(19) United States
(12) Patent Application Publication
(10) Pub. No.: US 2026/0237307 A1
(43) Pub. Date: Aug. 13, 2026

(54) ADVANCED URBAN AIR MOBILITY VEHICLE COMMUNICATION

(71) Applicant: Honeywell International Inc., Charlotte, NC (US)

(72) Inventors: Karthikeyan M, Madurai (IN); Gobinathan Baladhandapani, Madurai (IN); Srilakshmi Kurudi, Bangalore (IN)

(21) Appl. No.: 19/178,933

(22) Filed: Apr. 15, 2025

(30) Foreign Application Priority Data
Feb. 13, 2025 (IN) 202511012382

(51) Int. Cl. G08G 5/59; G07C 5/04; G08G 5/26; G08G 5/56; G08G 5/90; H04B 7/185

(52) U.S. Cl. CPC G08G 5/59; G07C 5/04; G08G 5/26; G08G 5/56; G08G 5/90; H04B 7/18506

(57) ABSTRACT

Approaches for urban air mobility vehicle communication are described. According to one example, historic flight data of one or more UAM vehicles flying over a target flight path is obtained. Based on the historic flight data, one or more blackout areas are identified in the target flight path where signal strength of communication signals received by the UAM vehicles from the ground station was below a threshold signal strength. For each of the one or more blackout areas, one or more intermediate nodes are determined that are to be within a prespecified distance from the blackout area. For each of the one or more blackout areas, a list of the one or more intermediate nodes is provided to a target UAM vehicle flying over the target flight path. The target UAM vehicle is to initiate establishing a wireless communication with at least one of the one or more intermediate nodes.

### BACKGROUND

Urban Air Mobility (UAM) is rapidly evolving as a transformative solution for transportation in congested urban environments and remote areas. UAM vehicles may include aerial vehicles such as helicopters, vertical take-off and landing (VTOL) aircraft, and unmanned aerial vehicles (UAVs). These aerial vehicles may be deployed in various applications, for example, urban air taxi services, emergency medical transport, surveillance, reconnaissance, mapping, and disaster relief operations.

The integration of UAM into existing transportation networks promises to reduce traffic congestion and improve overall urban mobility, making transportation more sustainable.

### SUMMARY OF INVENTION

This summary is provided to introduce concepts related to urban air mobility vehicle communication. This summary is not intended to identify essential features of the claimed subject matter nor is it intended for use in determining or limiting the scope of the claimed subject matter.

In an aspect of the present subject matter, a system for urban air mobility vehicle communication is disclosed. The system may include a flight control engine. The flight control engine may obtain historic flight data of one or more UAM vehicles flying over a target flight path. The historic flight data may indicate flight information of historical flights undertaken by the one or more UAM vehicles over the target flight path. The flight information may include details and records of communication between the one or more UAM vehicles with a ground station during the historical flights. The flight control engine may analyse the historic flight data to identify one or more blackout areas in the target flight path. These one or more blackout areas are the areas where signal strength of communication signals received by the UAM vehicles from the ground station was below a threshold signal strength. For each of the one or more blackout areas, the flight control engine may determine one or more intermediate nodes to be within a prespecified distance from the blackout area. The intermediate nodes may be utilized by the one or more UAM vehicles as communication nodes for relaying communication signals to the ground station during flight over the blackout area. For the target flight path, the flight control engine may generate a corresponding blackout area data having a list of the one or more blackout areas across the target flight path and the one or more intermediate nodes for each blackout area. The blackout area data is to be provided to all UAM vehicles flying over the target flight path.

In another aspect of the present subject matter, a method for urban air mobility vehicle communication is disclosed. The method may comprise obtaining historic flight data of one or more urban air mobility (UAM) vehicles flying over a target flight path. The historic flight data may indicate flight information of historical flights undertaken by the one or more UAM vehicles over the target flight path. The flight information may include details and records of communication between the one or more UAM vehicles with a ground station during the historical flights. The method may further comprise analysing the historic flight data to identify one or more blackout areas in the target flight path where signal strength of communication signals received by the UAM vehicles from the ground station was below a threshold signal strength. For each of the one or more blackout areas, the method may further comprise determining one or more intermediate nodes to be within a prespecified distance from the blackout area. The one or more intermediate nodes are to be utilized by the one or more UAM vehicles as communication nodes for relaying communication signals to the ground station during flight over the blackout area. The method furthermore comprises providing, for each of the one or more blackout areas, a list of the one or more intermediate nodes to a target UAM vehicle flying over the target flight path. Upon approaching the one or more blackout areas, the target UAM vehicle is to initiate establishing a wireless communication with at least one of the one or more intermediate nodes determined to be within the prespecified distance from the blackout area, thereby relaying communication signals including real-time flight data to the ground station.

In yet another aspect of the present subject matter, a non-transitory computer readable medium for workflow management is disclosed. The non-transitory computer readable medium has instructions stored thereon. The instructions, when executed by a processing resource, cause the processing resource to perform operations. In the operations, a list of one or more blackout areas identified along a target flight path based on historic flight data associated with the target flight path is received. The one or more blackout areas are areas where signal strength of communication signals received by one or more urban air mobility (UAM) vehicles from a ground station is below a threshold signal strength. The historic flight data may indicate flight information of historical flights undertaken by the one or more UAM vehicles over the target flight path. For each of the one or more blackout areas, a list of one or more intermediate nodes present within a prespecified distance from the one or more blackout areas is received. The one or more intermediate nodes are to be utilized by the one or more UAM vehicles as communication nodes for relaying communication signals to the ground station during flight over the blackout area. Upon approaching the blackout area, a wireless communication establishment with at least one of the one or more intermediate nodes is initiated, to relay communication signals including real-time flight data to the ground station.

### BRIEF DESCRIPTION OF FIGURES

Systems and/or methods are now described, in accordance with examples of the present subject matter and with reference to the accompanying figures, in which:

FIG. 1 illustrates a system for urban air mobility (UAM) vehicle communication, according to an example;

FIG. 2 illustrates a communication environment implementing a system for UAM communication, according to another example;

FIG. 3 illustrates a UAM communication environment, according to an example;

FIG. 4 illustrates a UAM communication environment, according to another example;

FIG. 5 illustrates a method for implementation of UAM vehicle communication, according to an example;

FIG. 6 illustrates a method 600 for establishing wireless communication with one or more intermediate nodes, according to an example;

FIG. 7 illustrates a method for generating a signal coverage map for a target flight path, according to an example;

FIG. 8 illustrates a signal coverage map for a target flight path, according to an example, and

FIG. 9 illustrates a computing environment implementing a non-transitory computer-readable medium for a UAM vehicle communication, according to an example.

### DETAILED DESCRIPTION

Conventional Urban Air Mobility (UAM) vehicles, such as helicopters, vertical take-off and landing (VTOL) aircraft, and unmanned aerial vehicles (UAVs), rely on robust communication systems to interact with ground stations. These communication systems facilitate the exchange of critical data, including flight status, navigation information, and real-time telemetry. Ground stations monitor the UAM vehicles' position, speed, altitude, and other vital parameters, ensuring safe and efficient operations. Additionally, communication signals enable the transmission of commands and updates from ground station to the UAM vehicle, allowing for adjustments in flight paths, emergency interventions, and coordination with other air traffic.

However, UAM vehicles typically operate at low altitudes, often below 1000 feet above ground level, in complex urban environments or remote areas. As a result, UAM vehicles may encounter numerous obstacles that may interfere with the communication signals transmitted and received by the UAM vehicles. Further, the conventional communication systems employed by most UAM vehicles have a limited effective range of only 5 to 10 nautical miles, which poses significant problems including safety concerns, operational limitations, command and control issues, and constraints on emergency response capabilities. This restricted communication range effectively constrains the operational radius of UAM vehicles, limits their utility for longer-distance flights or operations in remote areas, and can compromise the ability to maintain constant contact with air traffic control and other aircraft. This may result in limited communication and connectivity range or no communication between ground stations and the UAM vehicles, which may lead to several critical consequences. Firstly, it can compromise the safety of both passengers and the general public, as real-time data exchange is essential for navigation, collision avoidance, and emergency response. Secondly, it can hinder the efficiency and reliability of UAM operations, causing delays and disruptions in service. Additionally, limited connectivity can affect the coordination between multiple UAM vehicles, leading to potential traffic management issues in the airspace. Lastly, it can impact the overall user experience, as passengers may face uncertainties and inconveniences due to communication breakdowns. Ensuring robust and reliable communication systems is therefore crucial for the successful integration of UAM into urban transportation networks.

The present subject matter describes approaches for advanced urban air mobility vehicle communication, in particular, for extending communication range and improving connectivity for the urban air mobility vehicles, operating in areas with limited or no direct communication, with ground stations. According to an implementation of the present subject matter, historic flight data of one or more UAM vehicles flying over a target flight path is obtained. In an example, the historic flight data may indicate flight information from historical flights undertaken by the UAM vehicles over the target flight path. In an example, the flight information may include detailed records of communication between UAM vehicles and ground stations. The historic flight data is analysed, and blackout areas are identified in the target flight path. These blackout areas are areas where signal strength of communication signals exchanged between the UAM vehicles and the ground station was observed below a predetermined threshold. In an example, the blackout areas may be an area surrounding a geographical obstacle for the UAM vehicle such as a mountain or a skyscraper. In another example, the blackout area may be an area of high signal interference resulting in poor signal communication between UAM vehicles to the ground station.

For each blackout area, one or more intermediate nodes may be determined to be within a prespecified distance from the blackout area. The one or more intermediate nodes are to be utilized by the one or more UAM vehicles as communication nodes for relaying communication signals to the ground station during flight over the blackout area. In an example, the one or more intermediate nodes may include other ground stations such as mobile towers, relay stations, and another UAM vehicle(s) that may support relaying of communication signals that are flying in the blackout area or close to the blackout area. In an example, for each blackout area, a list of intermediate nodes is provided to a target UAM vehicle flying over the target flight path.

As a target UAM vehicle approaches a blackout area from the identified blackout areas, the target UAM vehicle initiates establishing wireless communication with at least one of the intermediate nodes. This connection allows the target UAM vehicle to relay communication signals, including critical real-time flight data, to the ground station, ensuring uninterrupted communication throughout the flight. For example, a target UAM vehicle is to travel from a point A to point B having a blackout area C in between the point A and point B in its flight path. The blackout area C may have one or more relay towers or another UAM vehicle that supports relaying of communication signals between the target UAM vehicle and the ground station. Upon approaching the blackout area C, the target UAM vehicle may establishes wireless communication with at least one of the intermediate nodes to relay communication signals to the ground station.

In another implementation of the present subject matter, a list of one or more blackout areas identified along a target flight path, is received by a UAM vehicle. The list is based on historic flight data associated with the target flight path. In an example, the one or more blackout areas are areas where signal strength of communication signals received by one or more urban air mobility (UAM) vehicles from a ground station is below a threshold signal strength. In an example, the historic flight data indicate flight information of historical flights undertaken by the one or more UAM vehicles over the target flight path. Further, for each blackout area, the target UAM vehicle may receive a list of one or more intermediate nodes that may present within a prespecified distance from the one or more blackout areas. The one or more intermediate nodes are to be utilized by the one or more UAM vehicles as communication nodes for relaying communication signals to the ground station during flight over the blackout area. In an example, upon approaching the blackout area, the target UAM vehicle may initiate establishing of a wireless communication with at least one of the intermediate nodes to relay communication signals including real-time flight data to the ground station. In an example, the real-time flight data may include flight information such as detailed records of communication between the target UAM vehicle and ground stations, flight plans, weather data, from the flight undertaken by the target UAM vehicle over the target flight path.

Therefore, the present approaches effectively address the critical challenge of limited communication range in UAM operations, particularly in remote, urban, or potentially hostile areas. By utilizing a network of authenticated intermediate nodes, implementing multi-hop relay capabilities, and continuously optimizing flight paths based on real-time data, the system extends the effective communication range far beyond the typical 5 to 10 nautical miles limit of direct UAM-to-ground station communication. The present invention thus enables expanding communication range and improving connectivity for Urban Air Mobility (UAM) vehicles with ground stations.

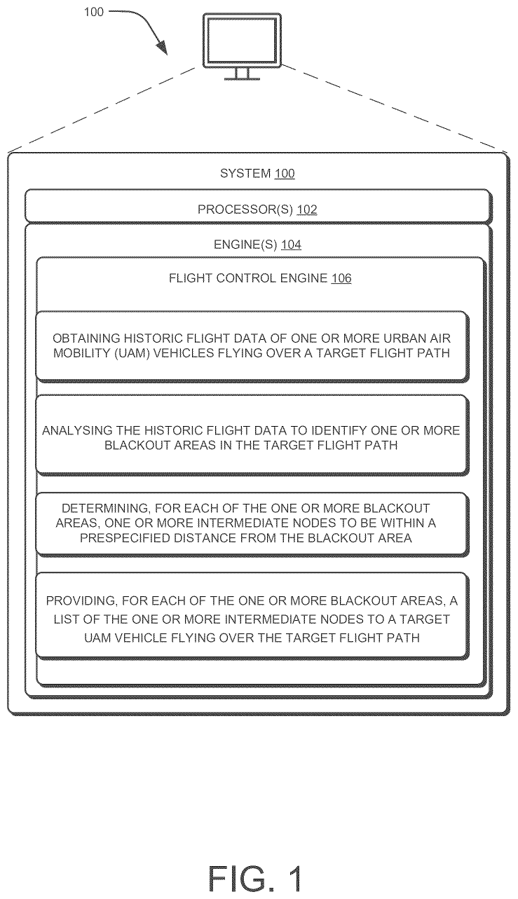

The present subject matter is further described with reference to FIG. 1 to FIG. 9. Wherever possible, the same reference numerals are used in the figures and the following description to refer to the same or similar parts. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for urban air mobility (UAM) vehicle communication, according to an example. Examples of UAM vehicle may include, but are not limited to, helicopters, vertical take-off and landing (VTOL) aircraft, and unmanned aerial vehicles (UAVs). Examples of the system 100 may include, but are not limited to, a laptop, a notebook computer, a server computer, a tablet computer. The system 100 may include processor(s) 102. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions. In one example, the system 100 may be a standalone server or may be a remote server on a cloud computing platform. In a preferred example, the system 100 may be a cloud-based system. In an example, the system 100 may be communicably coupled to a UAM vehicle database. In an example, the UAM vehicle database may include UAM vehicle data comprising information related to one or more UAM vehicles flying over one or more flight paths. In an example, the information related to one or more UAM vehicles may include information related to UAM vehicle type, UAM vehicle signal transmission capacity, etc.

The processor(s) 102, upon completion of a flight by the one or more UAM vehicles, may store that UAM vehicle data in the UAM vehicle database for further use.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 104 may be implemented as electronic circuitry. In an example, the engine(s) 104 may include a flight control engine 106. In an example, the flight control engine 106 may be communicably coupled to a user interface. The user interface may allow interaction of the system 100 with the user.

In an example, upon initiating the system 100, the flight control engine 106 may obtain historic flight data of one or more UAM vehicles over a target flight path. In an example, historic flight data indicates flight information from historical flights undertaken by one or more UAM vehicles over the target flight path. In an example, the flight information may include detailed records of communication between UAM vehicles and ground stations. The flight information may further include flight plans, weather data, navigation data, performance metrics, air traffic control (ATC) instructions, safety and compliance records, passenger and cargo information, emergency procedures etc. In an example, the flight control engine 106 may obtain the historic flight data from a ground station.

Post obtaining the historic flight data, the flight control engine 106 may analyse the historic flight data to identify one or more blackout areas in the target flight path. The blackout areas are the areas where signal strength of communication signals received by the one or more UAM vehicles from the ground station was observed below a predetermined threshold in past flights. Therefore, the one or more UAM vehicles may lose their communication with the ground station in the blackout areas.

For each blackout area, the flight control engine 106 may determine one or more intermediate nodes to be within a prespecified distance from the blackout area. The one or more intermediate nodes may act as communication nodes for relaying communication signals between the target UAM vehicle and the ground station during flight over the blackout area. In an example, the one or more intermediate nodes may include one or more intermediate ground stations such as mobile towers, relay stations, intermediate UAM vehicles that may support relaying of communication signals and are present in the blackout area or within a prescribed distance from the blackout area.

In an example, for each blackout area, a list of intermediate nodes is provided by the flight control engine 106 to a target UAM vehicle flying over the target flight path. For example, a list of intermediate UAM vehicles flying in the blackout area may be obtained from the UAM vehicle data and is provided to the target UAM vehicle.

Upon approaching the blackout area, the target UAM vehicle is to initiate establishing a wireless communication with at least one of the one or more intermediate nodes determined to be within the prespecified distance from the blackout area, thereby relaying communication signals to the ground station. In an example, the communication signals may include real-time flight data of the target UAM vehicle generated while flying over the flight path.

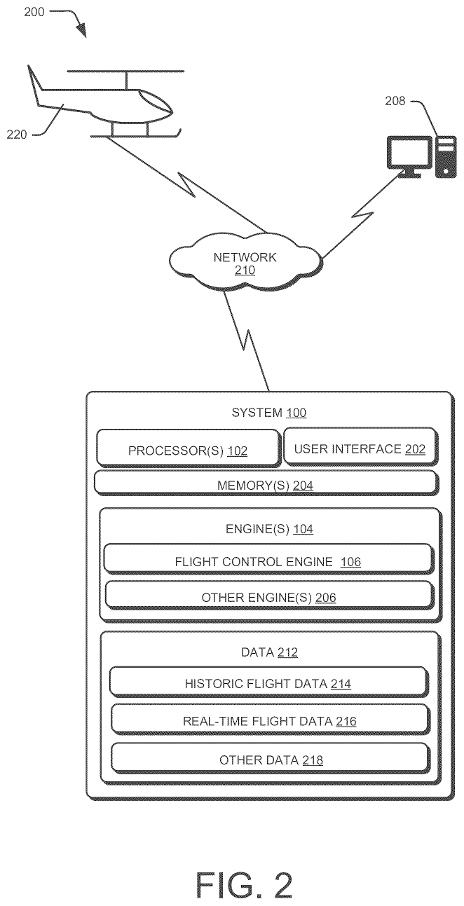

FIG. 2 illustrates a communication environment 200 implementing the system 100 for urban air mobility vehicle communication, according to an example. The system 100 is described in FIG. 1 and may include, but not limited to, a laptop, a notebook computer, a server computer, a tablet computer, and a smart phone. In addition to the processor(s) 102 and the engine(s) 104, the system 100 further includes user interface 202 and memory(s) 204. The user interface 202 may enable intercommunication between different logical as well as hardware components of the system 100. The memory(s) 204 may be a computer-readable medium, examples of which include volatile memory (e.g., RAM), and/or non-volatile memory (e.g., Erasable Programmable read-only memory, i.e., EPROM, flash memory, etc.). The memory(s) 204 may be an external memory, or internal memory, such as a flash drive, a compact disk drive, an external hard disk drive, or the like. The memory(s) 204 may further include data which either may be utilized or generated during the operation of the system 100.

In an example, the engine(s) 104, in addition to the flight control engine 106, may include other engine(s) 206. In an example, the other engine(s) 206 may include a map generating engine to generate a signal coverage map indicating areas within the flight path having communication signals in reference to a prespecified signal strength threshold.

In an example, the communication environment 200 may further include the UAM vehicle database 208. In one example, the UAM vehicle database 208 may be hosted virtually, for example, on a cloud-based platform. In another example, the UAM vehicle database 208 may be a stand-alone physical system geographically located either on a site or close to a site. Examples of the site may include, but are not limited to, a building or any other working environments in any industry associated to the UAM vehicles.

In an example the UAM vehicle database 208 may be accessed on the system 100 by the user to obtain various UAM vehicle related details such as UAM vehicle performance data, UAM vehicle operational data, etc. In an example, the UAM vehicle database 208 may be managed and owned by different entities and may be located at different geographical locations.

In an example, the system 100 and the UAM vehicle database 208 may communicably be coupled with each other over a network 210 and may exchange data and signals over the network 210. The network 210 may be a wireless network. The network 210 may also be an individual network or a collection of many such individual networks, interconnected with each other and functioning as a single large network, e.g., the Internet or an intranet. Examples of such individual networks include, but are not limited to, local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the network 210 may include various network entities, such as transceivers, gateways, and routers. In an example, the network 210 may include any communication network that uses any of the commonly used protocols, for example, Hypertext Transfer Protocol (HTTP), and Transmission Control Protocol/Internet Protocol (TCP/IP).

The system 100 may also include components, other than the depicted components, such as display, input/output interfaces, operating systems, applications, and other software or hardware components (not shown in the figures). In an example, the user interface 202 may allow the connection or coupling of the system 100 with the UAM vehicle database 208, through the network 210.

The other engine(s) 206 may be implemented as a combination of hardware and programming, for example, programmable instructions to implement a variety of functionalities of the other engine(s) 206. In examples described herein, such combinations of hardware and programming may be implemented in several different ways. For example, the programming for the other engine(s) 206 may be executable instructions. Such instructions may be stored on a non-transitory machine-readable storage medium which may be coupled either directly with the system 100 or indirectly (for example, through networked means). In an example, other engine(s) 206 may include a processing resource, for example, either a single processor or a combination of multiple processors, to execute such instructions. In the present examples, the non-transitory machine-readable storage medium may store instructions that, when executed by the processing resource, implement the other engine(s) 206. In other examples, the other engine(s) 206 may be implemented as electronic circuitry. In one example, the other engine(s) 206 may perform further implement functionalities that supplement functions performed by the system 100.

The data 212 includes data that is either received, stored, or generated as a result of functions implemented by the system 100. It may be further noted that information stored and available in the data 212 may be utilized by the engine(s) 104 for performing various functions by the system 100.

In an example, the data 212 may include historic flight data 214, real-time flight data 216, and other data 218. In an example, the historic flight data 214 may include flight information from historical flights undertaken by one or more UAM vehicles over a target flight path. In an example, the flight information may include detailed records of communication between UAM vehicles and ground stations. The flight information may further include flight plans, weather data, navigation data, performance metrics, air traffic control (ATC) instructions, safety and compliance records, passenger and cargo information, emergency procedures etc. In an example, the real-time flight data 216 may include flight data by the UAM vehicles generated at real-time during the flight. In an example, the other data 218 may include UAM vehicle data and other data generated by the other engine(s) 206. It may be noted that such examples are only indicative. The present approaches may be applicable to other examples without deviating from the scope of the present subject matter.

In an example, the system 100 may be operated by a user for UAM vehicle communication. In an example, the user may be a pilot of an UAM vehicle. In another example, the user may be a UAM vehicle operator associated with an UAM vehicle organization. For instance, the UAM vehicle operator may monitor and operate multiple UAM vehicles flying on a target flight path. In an example, the system 100 may automatically operate the UAM vehicle communication process upon initiating. In another example, the system 100 may operate manually based on inputs provided by the user.

Initially, in the system 100, the historic flight data 214 of one or more UAM vehicles flying over a target flight path is obtained by the flight control engine 106. In an example, the flight control engine 106 may obtain the historic flight data 214 from a ground station. In another example, the flight control engine 106 may obtain the historic flight data 214 from the UAM vehicle database 208. In another example, the historic flight data 214 may be obtained from air traffic management systems associated with the UAM vehicles.

Once the historic flight data 214 are obtained, the flight control engine 106 may identify one or more blackout areas in the target flight path by analysing the historic flight data 214. The blackout areas are areas where signal strength of communication signals received by the one or more UAM vehicles from the ground station was observed below a predetermined threshold in past flights. Therefore, in the blackout areas, the one or more UAM vehicles may lose their communication with the ground station.

The flight control engine 106 may then, for each blackout area, determine one or more intermediate nodes 220 to be within a prespecified distance from the blackout area. The one or more intermediate nodes 220 may act as communication nodes for relaying communication signals between the target UAM vehicle and the ground station during flight over the blackout area. In an example, the one or more intermediate nodes 220 may be static intermediate nodes, such as mobile towers, relay towers, that supports relaying communication signals and may be stationary near the blackout area throughout a day. In another example, the one or more intermediate nodes 220 may be dynamic intermediate nodes, such as, another UAM vehicle(s) that may be present near the blackout area at specific time periods of a day and supports relaying communication signals. In an example, the one or more intermediate nodes 220 may be strategically selected to serve as communication relays, effectively creating a mesh network to maintain continuous connectivity. The selection process takes into account factors such as the intermediate node's location, altitude, transmission power, and historical reliability to ensure optimal relay performance. In an example, for each blackout area, a list of the one or more intermediate nodes 220 is provided to the target UAM vehicle flying over the target flight path by the system 100.

Once a target UAM vehicle that approaches a blackout area from the identified blackout areas, the target UAM vehicle initiates establishing wireless communication with at least one of the intermediate nodes 220. In an example, while establishing wireless communication with the intermediate node, the system 100 may generate a relay authentication message indicative of authorisation for relaying communication signals. In an example, the relay authentication message may include a unique identification code associated with the target UAM vehicle. The system 100 may transmit the relay authentication message to the intermediate node. When the target UAM vehicle initiates establishing wireless communication with the intermediate node, the intermediate node is authenticated for the wireless communication based on a verification of the relay authentication message. In an example, the verification may include matching the identification code associated with the target UAM vehicle with the prestored identification codes in the intermediate nodes. In an example, the verification may include matching the identification code associated with the target UAM vehicle with the prestored identification codes stored within UAM vehicle database 208. In an example, upon receiving the real-time flight data, the system 100 may obtain transmission signal parameters and flight parameters of the target UAM vehicle. The transmission signal parameters are indicative of signal quality of communication signals transmitted and received by the target UAM vehicle during a flight over the target flight path. The flight parameters are indicative of flight operation information during the flight, such as flight plans, load sheets, maintenance logs, weather data etc. In an example, the system 100 may compute a signal coverage data for the flight path based on the transmission signal parameters and flight parameters. In an example, the signal coverage data is to be provided to all UAM vehicles flying over the target flight path. Further, the map generating engine may generate a corresponding blackout area data having a list of the one or more blackout areas across the target flight path and the one or more intermediate nodes for each blackout area. The blackout area data may be provided to all UAM vehicles flying over the target flight path. Further, the map generating engine may generate a signal coverage map based on the signal coverage data for the target flight path. In an example, the signal coverage map may indicate one or more areas where signal strength of communication signals received by the UAM vehicles from the ground station is above the predetermined signal strength threshold.

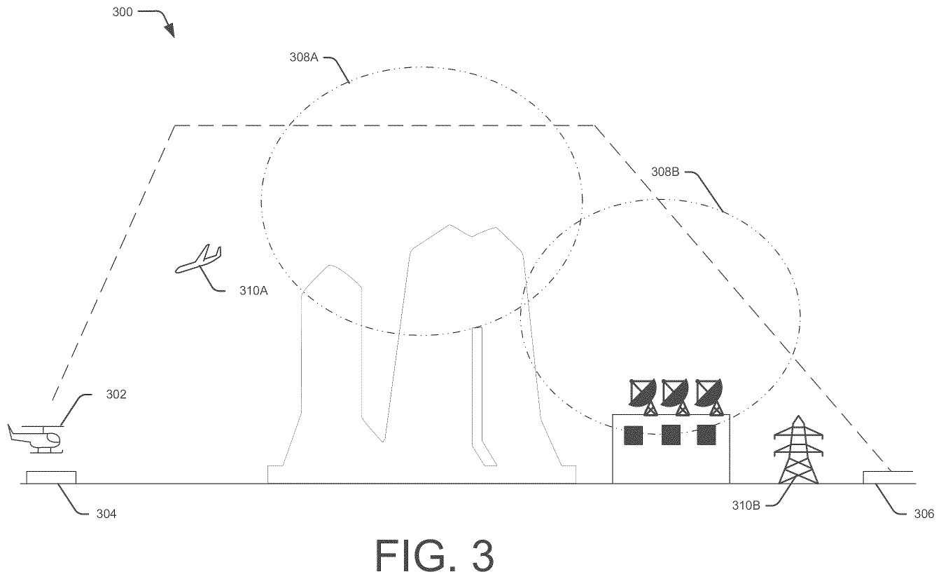

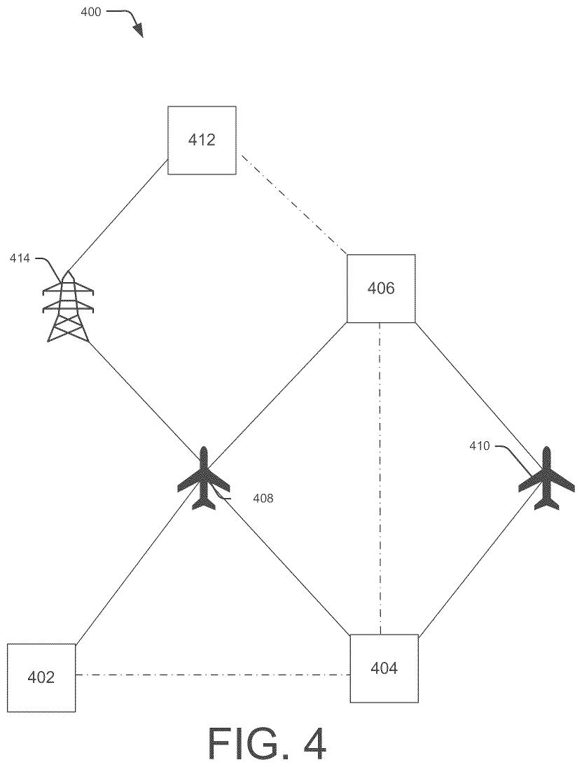

Thus, the wireless connection with the intermediate nodes allows the target UAM vehicle to relay communication signals, including critical real-time flight data, to the ground station, ensuring uninterrupted communication throughout the flight. Exemplary UAM vehicle communication environments are further described with reference to FIG. 3 and FIG. 4.

FIG. 3 illustrates a UAM vehicle communication environment 300, according to an example. In an example, a target UAM vehicle 302 may have to fly on a flight path from take-off point 304 to a landing point 306. In an example, ground stations for the one or more UAM vehicles flying on the flying path from 304 to 306 are situated at the take-off point 304 and the landing point 306. In an example, the target UAM vehicle 302 is communicably coupled to the system 100 via the network 210. When the Target UAM vehicle 302 is stationed at the take-off point 304, the Target UAM vehicle 302 is wirelessly communicating with the ground station situated at the take-off point 304. Further, the ground station 304 is wirelessly communicating with the system 100. The Target UAM vehicle 302 may communicate with the ground station only when the signal strength of communication signals between the Target UAM vehicle 302 and the ground station is above a threshold signal strength.

Initially, in the system 100, the historic flight data 214 of one or more UAM vehicles flying over the target flight path, i.e., from the take-off point 304 to the landing point 306, is obtained by the flight control engine 106 of the system 100. Based on the historic flight data 214, the flight control engine 106 may identify one or more blackout areas 308A, 308B, collectively referred as black out area 308, in the target flight path. In the black out area 308, signal strength of communication signals received by the one or more UAM vehicles from the ground station was observed below the threshold signal strength in past flights. In an example, the system 100 may generate a corresponding blackout area data having a list of the one or more blackout areas across the target flight path. In an example, the blackout area data is to be provided to all UAM vehicles flying over the target flight path. As show in FIG. 3, the black out area 308A is a mountain area where the signal strength of communication signals was observed to be below the threshold signal strength. The black out area 308B is an area of signals with high interference that may cause the signal strength of communication signals between the ground station, situated at the landing point 306, and the UAM vehicles to be below the threshold signal strength. As a result, the target UAM vehicle 302 may not be able to retain its communication with the ground stations upon entering these black out areas 308. In an example, the target UAM vehicle 302 may receive a list of the blackout areas identified along the target flight path from the system 100.

In an example, for each of the black out area 308, the system 100 may determine one or more intermediate nodes 310A and 310B, to be within a prespecified distance from the blackout area 308, such that the intermediate nodes may act as communication node for relaying communication signals between the target UAM vehicle 302 and the ground station during flight over the blackout area 308. The one or more intermediate nodes 310A and 310B may collectively referred to as intermediate nodes 310 hereinafter. As shown in FIG. 3, the intermediate node 310A is a dynamic intermediate node, i.e., another UAM vehicle that is flying within a prespecified distance from the blackout area 308A and supports relaying communication signals between the target UAM vehicle 302 and the ground station at the take-off point 304. Further, the intermediate nodes 310B is a static intermediate node 310B which is mobile tower that supports relaying communication signals. The intermediate nodes 310B is situated within a prespecified distance from the blackout area 308B. In an example, the target UAM vehicle 302, for each of the blackout areas 308, may receive a list of the intermediate nodes 310 present within the prespecified distance from the blackout areas 308. In an example, the blackout area data may further include a list of the intermediate nodes 310 the blackout area 308. The blackout area data is to be provided to all UAM vehicles flying over the target flight path.

In an example, when the target UAM vehicle 302 approaches the blackout area 308A, the target UAM vehicle 302 initiates establishing wireless communication with the intermediate node 310A. The intermediate node 310A may relay communication signals between the Target UAM vehicle 302 and the ground station situated at the take-off point 304. When the target UAM vehicle 302 approaches the blackout area 308B, the target UAM vehicle 302 initiates establishing wireless communication with the intermediate node 310B. The intermediate node 310B may relay communication signals between the Target UAM vehicle 302 and the ground station situated at the landing point 306. Thus, by using the intermediate nodes 310 as communication nodes, the target UAM vehicle 302 may relay communication signals, including real-time flight data, to the ground station, ensuring uninterrupted communication throughout the flight.

FIG. 4 illustrates another UAM vehicle communication environment 400, according to an example. In the UAM vehicle communication environment 400, a target UAM vehicle (not shown in FIG. 4) is to travel from point 402 to point 406 while passing through a point 404. The point 402 and 406 have ground stations. In an example, one or more UAM vehicles are flying in the target flight path from point 402 to point 406 and may be communicably coupled to the system 100. In an example, the target flight path from point 402 to 406 include a first flight path from point 402 to point 404 and a second flight path from point 404 to point 406. The first flight path and the second flight path may include one or more blackout areas. As a result, the flight path between the point 402 and the point 404 is a path where the signal strength of communication signals between the one or more UAM vehicles and the ground station was observed to be below the threshold signal strength. Similarly, the signal strength of communication signals between the one or more UAM vehicles and the ground station was observed to be below the threshold signal strength in the second flight path. In an example, the system 100 analyse the historic flight data 214 which is indicative of flight information of historical flights undertaken by the one or more UAM vehicles over the target flight path from point 402 to point 406. Based on the analysis, the system 100 identify one or more blackout areas in the target flight path from point 402 to point 406. In an example, the target UAM vehicle may receive a list of these blackout areas identified based on historic flight data 214. In an example, one or more intermediate nodes that may support relaying communication signals between the UAM vehicles and the ground stations are present within a prespecified distance from the black out areas. As shown in FIG. 4, an intermediate node 408 is present within a prespecified distance from the black out areas within the first flight path. Further, an intermediate node 410 is present within a prespecified distance from the black out areas within the second flight path. In an example, the target UAM vehicle may receive a list of the intermediate nodes in the target flight path from point 402 to point 406. Once the target UAM vehicle approaches the one or more blackout areas in the first flight path, the target UAM vehicle may initiate establishing a wireless communication with the intermediate node 408. For the second flight path, the target UAM vehicle may initiate establishing a wireless communication with the intermediate node 410. Therefore, by using the intermediate nodes 408 and 410, the target UAM vehicle remain in a wireless communication with the ground station throughout the target flight path 402 to 406.

In another embodiment, the intermediate node 408 may be present within a prespecified distance from the black out areas within the first flight path and the second flight path. Therefore, the target UAM vehicle upon approaching the one or more blackout areas from the first flight path may initiate establishing a wireless communication with the intermediate node 408. Further, the target UAM vehicle upon approaching the one or more blackout areas from the second flight path may continue relaying communication signals using the intermediate node 408.

In another embodiment, the target UAM vehicle may have to travel from point 402 to a point 412 via the point 406. In an example, a third flight path between point 406 and the point 412 have one or more blackout areas. In an example, an intermediate node, i.e., a mobile tower 414 that supports relaying of communication signals is located in an area within a prespecified distance from the black out areas of the third flight path. In an example, the target UAM vehicle may receive a list of intermediate nodes for the target flight path from point 402 to point 412 that includes the intermediate node (UAM vehicle) 408 and the intermediate node (mobile tower) 414. Upon approaching the one or more blackout areas of the first flight path from point 402 to point 406, the target UAM vehicle may establish a wireless communication with intermediate node 408. Further, upon approaching the one or more blackout areas of the third flight path from point 406 to point 412, the target UAM vehicle may establish a wireless communication with intermediate node 414 to relay communication signals to the ground stations. Therefore, by using the intermediate nodes 408 and 414, the target UAM vehicle remain in a wireless communication with the ground station throughout the target flight path 402 to 412.

In another example, the system 100 may determine that no intermediate node may be present within a prespecified distance from the black out areas. The system 100 may ascertain based on the historic flight data, a secondary flight path, as an alternate to the target flight path, wherein the signal strength of communication signals received by the UAM vehicles from the ground station is above the predetermined signal strength threshold. In an example, the target UAM vehicle may receive the secondary flight path as an alternative to the target flight path. In another example, the system 100 upon determining one that no intermediate node is present within the prespecified distance from the black out area, the system 100 may request an intermediate node, for e.g., undeployed UAM vehicle that supports relaying of communication signals, to fly to the blackout area for relaying the communication signals. This may conserve energy and bandwidth of the target UAV vehicle.

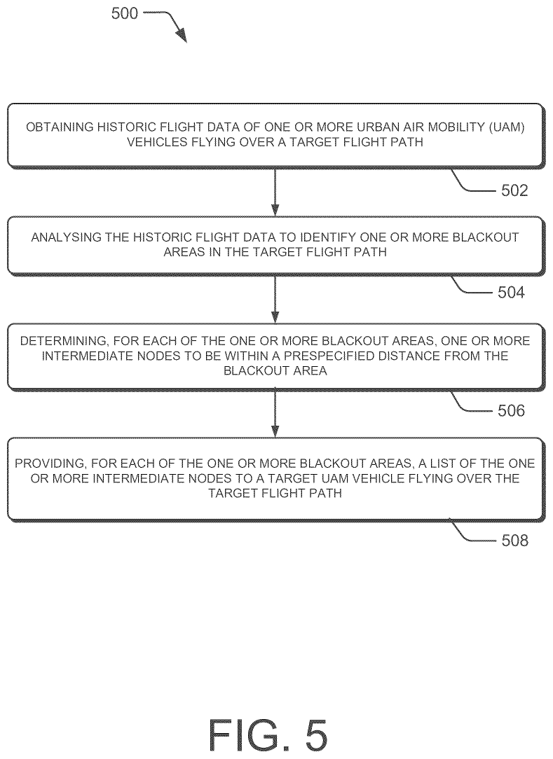

FIG. 5 illustrates a method 500 for implementation of UAM vehicle communication, according to an example. The order in which the method is described is not intended to be construed as a limitation, and any number of the described method blocks may be combined in any order to implement the method, or an alternative method. Further, the method 500 may be implemented by processing resource or computing device(s) through any suitable hardware, non-transitory machine-readable instructions, or combination thereof.

It may also be understood that method 500 may be performed by programmed computing devices, such as the system 100, as depicted in FIG. 1 and FIG. 2. Furthermore, the method 500 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 500 is described below with reference to the system 100 as described above, other suitable systems for the execution of these methods may also be utilized. Additionally, implementation of these methods is not limited to such examples.

At block 502, the historic flight data 214 of one or more UAM vehicles flying over a target flight path is obtained. The historic flight data 214 may include flight information such flight plans, navigation data, performance metrics, air traffic control (ATC) instructions, safety and compliance records, passenger and cargo information, from historical flights undertaken by the one or more UAM vehicles over the target flight path. In an example, the historic flight data 214 may be obtained from a ground station. In another example, the historic flight data 214 may be obtained from the UAM vehicle database 208. In another example, the historic flight data 214 may be obtained from air traffic management systems associated with the UAM vehicles.

At block 504, post-obtaining the historic flight data 214 of the one or more UAM vehicles, the historic flight data 214 is analysed to identify one or more blackout areas in the target flight path. The blackout areas refer herein to areas where signal strength of communication signals exchanged between the one or more UAM vehicles and the ground station was observed below a predetermined threshold in past flights undertaken by the one or more UAM vehicles.

At block 506, for each blackout area, one or more intermediate nodes 220 determined that are within a prespecified distance from the blackout area. In an example, the one or more intermediate nodes 220 may be static intermediate nodes, such as mobile towers, relay towers etc that are situated within the prespecified distance from the blackout area and supports relaying communication signals. In another example, the one or more intermediate nodes 220 may be dynamic intermediate nodes, such as, another UAM vehicle(s) that may be present within the blackout area at specific time periods of a day and supports relaying communication signals. The one or more intermediate nodes 220 may act as communication nodes for relaying communication signals between the target UAM vehicle and the ground station during flight over the blackout area.

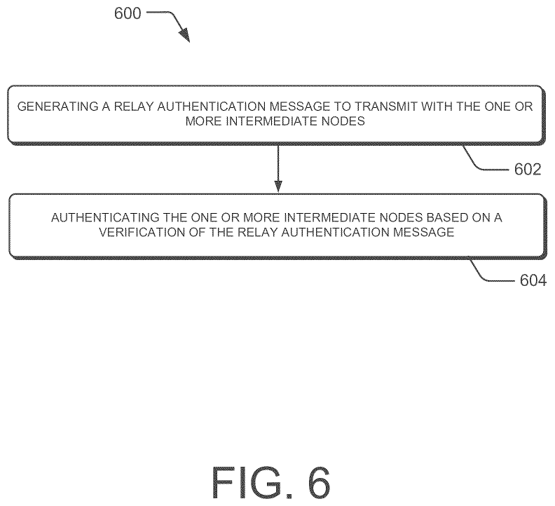

Returning to FIG. 5, at block 508, for each blackout area, a list of the one or more intermediate nodes 220 is provided to the target UAM vehicle flying over the target flight path. Once a target UAM vehicle that approaches a blackout area from the identified blackout areas, the target UAM vehicle initiates establishing wireless communication with at least one of the intermediate nodes 220. The establishment of the wireless communication of the target UAM vehicle with the at least one of the intermediate nodes is further explained in reference to the FIG. 6.

FIG. 6 illustrates a method 600 for establishing wireless communication with one or more intermediate nodes, according to an example.

At block 602, a relay authentication message indicative of authorisation for relaying communication signals is generated. The relay authentication message is transmitted to an intermediate node, from the one or more intermediate nodes, with which the target UAM vehicle establishing wireless communication. In an example, the relay authentication message may include a unique identification code associated with the target UAM vehicle.

At block 604, the intermediate node is authenticated for the wireless communication based on a verification of the relay authentication message. In an example, the verification may include matching the identification code associated with the target UAM vehicle with the prestored identification codes in the intermediate nodes. In an example, the verification may include matching the identification code associated with the target UAM vehicle with the prestored identification codes stored within UAM vehicle database 208.

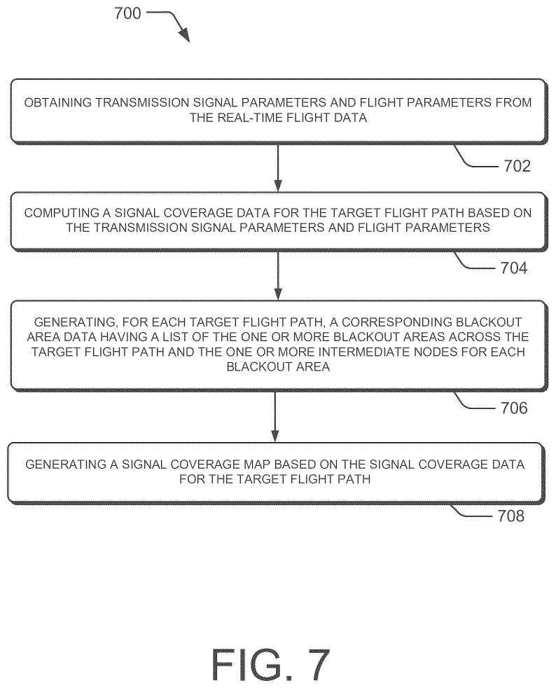

FIG. 7 illustrates a method 700 for generating a signal coverage map for the target flight path, according to an example.

At block 702, transmission signal parameters and flight parameters of the target UAM vehicle are obtained from the real-time flight data associated to the target UAM vehicle. In an example, the transmission signal parameters are indicative of signal quality of communication signals transmitted and received by the target UAM vehicle during a flight over the target flight path. In an example, the flight parameters are indicative of flight operation information during the flight, such as flight plans, load sheets, maintenance logs, etc.

At block 704, a signal coverage data for the target flight path based on the transmission signal parameters and flight parameters is computed. The signal coverage data may be provided to the one or more UAM vehicles flying over the target flight path.

At block 706, for each target flight path, a corresponding blackout area data is generated. The corresponding blackout area data may include a list of the one or more blackout areas across the target flight path and the one or more intermediate nodes for each blackout area. In an example, the blackout area data may be provided to the one or more UAM vehicles flying over the target flight path.

At block 708, a signal coverage map is generated based on the signal coverage data for the target flight path. In an example, the signal coverage map indicates one or more areas where signal strength of communication signals received by the UAM vehicles from the ground station is above the predetermined signal strength threshold.

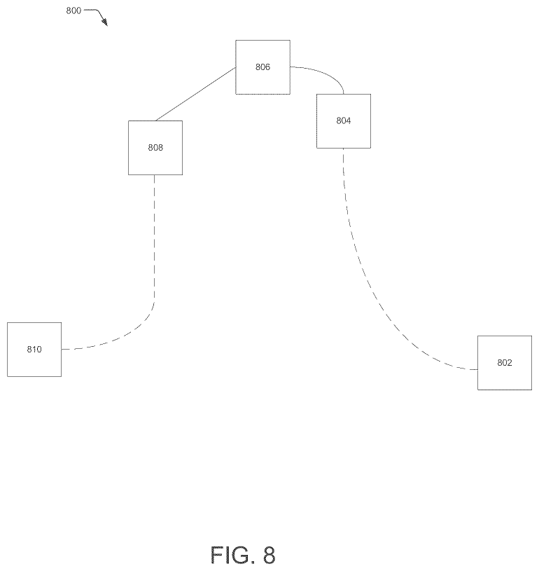

FIG. 8 illustrates a signal coverage map 800 for the target flight path, according to an example. A target UAM vehicle, similar to the target UAM vehicle 302, has to fly over a target flight path. The target flight path includes five stations 802, 804, 806, 808, and 810. Upon completing the flight, the real-time flight data associated with the target UAM vehicle on the target flight path is obtained. In real-time data may include transmission signal parameters and flight parameters of the target UAM vehicle for the flight path between the station 802 to 804, the flight path between the station 804 to 806, the flight path between the station 804 to 806, the flight path between the station 806 to 808, and the flight path between the station 808 to 810. Based on the real-time flight data, transmission signal parameters and flight parameters of the target UAM vehicle are obtained. Further, a signal coverage data for the target flight path from the station 802 to station 810 is computed. Based on the signal coverage data, a signal coverage map is generated for the target flight path. In an example, signal strength of communication signals for the flight path between the stations 802 to 804 and stations 808 to 810 is below the predetermined signal strength threshold as indicated in the signal coverage map 800. In another example, signal strength of communication signals for the flight path between the stations 804 to 806 and stations 806 to 808 is above the predetermined signal strength threshold.

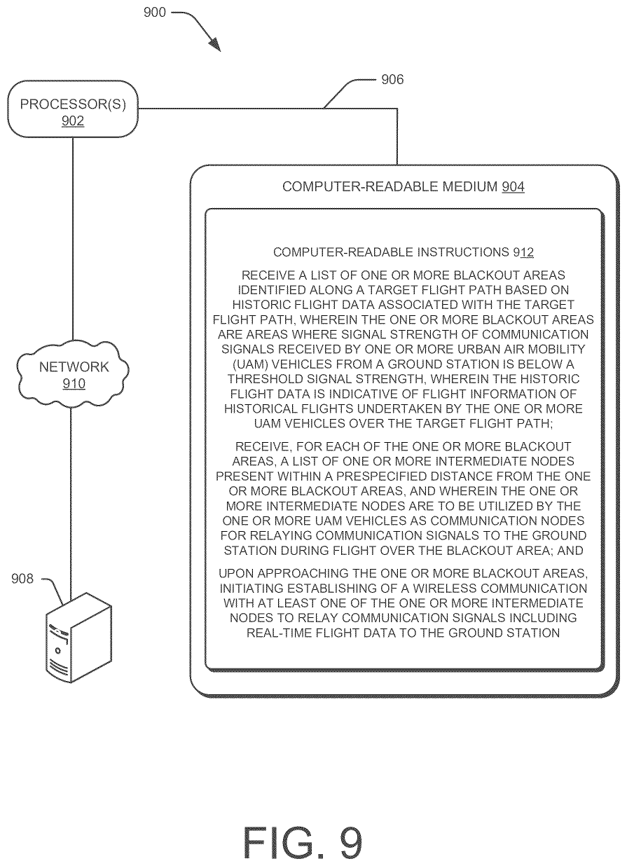

FIG. 9 illustrates a computing environment 900 implementing a non-transitory computer-readable medium for a workflow management process, according to an example. In an example, the computing environment 900 includes processor(s) 902 communicatively coupled to a non-transitory computer-readable medium 904 through a communication link 906. In one example, the communication link 906 is a bus system having a set of physical connections (like wires or traces on a circuit board) that allow data transfer. In an example implementation, the computing environment 900 may be for example, the communication environment 200. In an example, the processor(s) 902 may have one or more processing resources for fetching and executing computer-readable instructions from the non-transitory computer-readable medium 904. The processor(s) 902 and the non-transitory computer-readable medium 904 may be implemented, for example, by the UAM vehicle (as has been described in conjunction with the preceding figures).

The non-transitory computer-readable medium 904 may be, for example, an internal memory device or an external memory device. In an example implementation, the communication link 906 may be a network communication link. The processor(s) 902 and the non-transitory computer-readable medium 904 may also be communicatively coupled to one or more servers 908 over a network 910. The one or more servers 908 may be the UAM vehicle database 208 as described in conjunction with FIG. 2. In an example, the processor(s) 902 may be similar to the processor(s) 102. The network 910 may similar to the network 210 of FIG. 2.

In an example implementation, the non-transitory computer-readable medium 904 may include a set of computer-readable instructions 912 which may be accessed by the processor(s) 902 through the communication link 906. Referring to FIG. 9, in an example, the non-transitory computer-readable medium 904 may include instructions that may cause the processor(s) 902 to obtain historic flight data of one or more UAM vehicles flying over a target flight path. In an example, the historic flight data may be obtained from a ground station. In an example, the non-transitory computer-readable medium 904 may include instructions that may cause the processor(s) 902 to identify one or more blackout areas in the target flight path by analysing the historic flight data 214. In an example, the non-transitory computer-readable medium 904 may include instructions 912 that may cause the processor(s) 902 to receive a list of the one or more blackout areas identified along the target flight path based on historic flight data associated with the target flight path. In an example, the one or more blackout areas are areas where signal strength of communication signals received by one or more UAM vehicles from the ground station is below a threshold signal strength. Further, the historic flight data may be indicative of flight information of historical flights undertaken by the one or more UAM vehicles over the target flight path.

For each of the one or more blackout areas, a list of one or more intermediate nodes that are present within a prespecified distance from the one or more blackout areas is received. The one or more intermediate nodes may be utilized by the one or more UAM vehicles as communication nodes for relaying communication signals to the ground station during flight over the blackout area. In an example, the one or more intermediate nodes may be static intermediate nodes, such as mobile towers, relay towers, that supports relaying communication signals and may be stationary near the blackout area throughout a day. In another example, the one or more intermediate nodes may be dynamic intermediate nodes, such as, another UAM vehicle(s) that may be present near the blackout area at specific time periods of a day and supports relaying communication signals. In an example, upon approaching at least one of the one or more blackout areas, a wireless communication establishment is initiated with at least one of the one or more intermediate nodes to relay communication signals including real-time flight data to the ground station. In an example, the communication signals may include real-time flight data of the target UAM vehicle generated while flying over the flight path.

The present approaches effectively tackle the challenge of limited communication range in UAM operations. The enhanced communication capabilities offer several key advantages for UAM operations. Improved safety is achieved through reliable communication, reducing the risk of accidents. Further the present approaches facilitate flexibility to adapt to various environments, including urban, remote, and potentially hostile areas. Real-time monitoring ensures continuous data exchange, enabling quick responses to any issues, thereby creating a more robust and efficient UAM ecosystem.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A method comprising:
obtaining historic flight data of one or more urban air mobility (UAM) vehicles flying over a target flight path, wherein the historic flight data is indicative of flight information of historical flights undertaken by the one or more UAM vehicles over the target flight path, and wherein the flight information includes details and records of communication between the one or more UAM vehicles with a ground station during the historical flights;
analysing the historic flight data to identify one or more blackout areas in the target flight path where signal strength of communication signals received by the UAM vehicles from the ground station was below a threshold signal strength;
determining, for each of the one or more blackout areas, one or more intermediate nodes to be within a prespecified distance from the blackout area, wherein the one or more intermediate nodes are to be utilized by the one or more UAM vehicles as communication nodes for relaying communication signals to the ground station during flight over the blackout area;
providing, for each of the one or more blackout areas, a list of the one or more intermediate nodes to a target UAM vehicle flying over the target flight path, wherein upon approaching the one or more blackout areas, the target UAM vehicle is to initiate establishing a wireless communication with at least one of the one or more intermediate nodes determined to be within the prespecified distance from the blackout area, to relay communication signals including real-time flight data to the ground station.

2. The method as claimed in claim 1, further comprising:
upon determining that no intermediate nodes are present within the prespecified distance from the one or more blackout areas, ascertaining, based on the historic flight data, a secondary flight path, as an alternate to the target flight path, wherein the signal strength of communication signals received by the UAM vehicles from the ground station is above a predetermined signal strength threshold.

3. The method as claimed in claim 1, wherein the one or more intermediate nodes comprises at least one dynamic intermediate node ascertained to be present near the blackout area at specific time periods of a day, and wherein the at least one dynamic intermediate node is another UAM vehicle.

4. The method as claimed in claim 1, wherein the one or more intermediate nodes comprises at least one static intermediate node ascertained to be stationary near the blackout area throughout a day, wherein the at least one static intermediate node is another ground station that supports relaying communication signals.

5. The method as claimed in claim 1, wherein establishing a wireless communication with the one or more intermediate nodes comprises:
generating a relay authentication message for transmitting to the one or more intermediate nodes, wherein the relay authentication message is indicative of authorisation for relaying communication signals; and
authenticating the one or more intermediate nodes based on a verification of the relay authentication message.

6. The method as claimed in claim 1, further comprising:
obtaining transmission signal parameters and flight parameters from the real-time flight data, wherein:
the transmission signal parameters are indicative of signal quality of communication signals transmitted and received by the target UAM vehicle during a flight over the target flight path, for which the real-time flight data is being obtained; and
the flight parameters are indicative of flight operation information during the flight; and.
computing a signal coverage data for the target flight path based on the transmission signal parameters and flight parameters.

7. The method as claimed in claim 6, further comprising:
generating, for each target flight path, a corresponding blackout area data having a list of the one or more blackout areas across the target flight path and the one or more intermediate nodes for each blackout area, wherein the blackout area data is to be provided to all UAM vehicles flying over the target flight path; and
generating a signal coverage map based on the signal coverage data for the target flight path, wherein the signal coverage map indicates one or more areas where signal strength of communication signals received by the UAM vehicles from the ground station is above a predetermined signal strength threshold, wherein the signal coverage data is to be provided to all UAM vehicles flying over the target flight path.

8. A system comprising:
a flight control engine to:
obtain historic flight data of one or more urban air mobility (UAM) vehicles flying over a target flight path, wherein the historic flight data is indicative of flight information of historical flights undertaken by the one or more UAM vehicles over the target flight path, and wherein the flight information includes details and records of communication between the one or more UAM vehicles with a ground station during the historical flights;
analyse the historic flight data to identify one or more blackout areas in the target flight path where signal strength of communication signals received by the UAM vehicles from the ground station was below a threshold signal strength;
determine, for each of the one or more blackout areas, one or more intermediate nodes to be within a prespecified distance from the blackout area, wherein the one or more intermediate nodes are to be utilized by the one or more UAM vehicles as communication nodes for relaying communication signals to the ground station during flight over the blackout area;
generate, for each the target flight path, a corresponding blackout area data having a list of the one or more blackout areas across the target flight path and the one or more intermediate nodes for each blackout area, wherein the blackout area data is to be provided to all UAM vehicles flying over the target flight path.

9. The system as claimed in claim 8, wherein the flight control engine is to:
upon determining the one or more intermediate nodes are not within the prespecified distance from the one or more blackout areas, ascertain, based on the historic flight data, a secondary flight path, as an alternate to the target flight path, wherein the signal strength of communication signals received by the UAM vehicles from the ground station is above a predetermined signal strength threshold.

10. The system as claimed in claim 8, wherein the one or more intermediate nodes comprises at least one dynamic intermediate node ascertained to be present near the blackout area at specific time periods of a day and wherein the at least one dynamic intermediate node is another UAM vehicle.

11. The system as claimed in claim 8, wherein the one or more intermediate nodes comprises at least one static intermediate node ascertained to be stationary near the blackout area throughout a day, wherein the at least one static intermediate node is another ground station that supports relaying communication signals.

12. The system as claimed in claim 8, wherein the flight control engine is to:
generate a relay authentication message for transmitting to the one or more intermediate nodes, wherein the relay authentication message is indicative of authorisation for relaying communication signals; and
authenticate the one or more intermediate nodes based on a verification of the relay authentication message.

13. The system as claimed in claim 8, wherein the flight control engine is to:
obtain transmission signal parameters and flight parameters from the real-time flight data, wherein:
the transmission signal parameters are indicative of signal quality of communication signals transmitted and received by the target UAM vehicle during a flight over the target flight path, for which the real-time flight data is being obtained; and
the flight parameters are indicative of flight operation information during the flight; and
compute a signal coverage data for the target flight path based on the transmission signal parameters and flight parameters.

14. The system as claimed in claim 8, wherein the flight control engine is to:
generate, for each the target flight path, a corresponding blackout area data having a list of the one or more blackout areas across the target flight path and the one or more intermediate nodes for each blackout area, wherein the blackout area data is to be provided to all UAM vehicles flying over the target flight path; and
generate a signal coverage map based on the signal coverage data for the target flight path, wherein the signal coverage map indicates one or more areas where signal strength of communication signals received by the UAM vehicles from the ground station is above the predetermined signal strength threshold, wherein the signal coverage data is to be provided to all UAM vehicles flying over the target flight path.

15. A non-transitory computer-readable medium having instructions stored thereon, the instructions, when executed by a processor, cause the processor to perform operations comprising:
receive a list of one or more blackout areas identified along a target flight path based on historic flight data associated with the target flight path, wherein the one or more blackout areas are areas where signal strength of communication signals received by one or more urban air mobility (UAM) vehicles from a ground station is below a threshold signal strength, wherein the historic flight data is indicative of flight information of historical flights undertaken by the one or more UAM vehicles over the target flight path;
receive, for each of the one or more blackout areas, a list of one or more intermediate nodes present within a prespecified distance from the one or more blackout areas, and wherein the one or more intermediate nodes are to be utilized by the one or more UAM vehicles as communication nodes for relaying communication signals to the ground station during flight over the blackout area;
upon approaching the one or more blackout areas, initiating establishing of a wireless communication with at least one of the one or more intermediate nodes to relay communication signals including real-time flight data to the ground station.

16. The non-transitory computer-readable medium as claimed in claim 15, further comprising:
receiving, based on the historic flight data, a secondary flight path, as an alternate to the target flight path, wherein the signal strength of communication signals received by the UAM vehicles from the ground station is above the predetermined signal strength threshold.

17. The non-transitory computer-readable medium as claimed in claim 15, wherein the one or more intermediate nodes comprises at least one dynamic intermediate node ascertained to be present near the blackout area at specific time periods of a day, and wherein the at least one dynamic intermediate node is another UAM vehicle.

18. The non-transitory computer-readable medium as claimed in claim 15, wherein the one or more intermediate nodes comprises at least one static intermediate node ascertained to be stationary near the blackout area throughout a day, wherein the at least one static intermediate node is another ground station that supports relaying communication signals.

19. The non-transitory computer-readable medium as claimed in claim 15, further comprising:
transmitting a relay authentication message to the one or more intermediate nodes, wherein the relay authentication message is indicative of authorisation for relaying communication signals; and
establishing the wireless communication with the one or more intermediate nodes after the one or more intermediate nodes are authenticated based on verification of the relay authentication message.

20. The non-transitory computer-readable medium as claimed in claim 15, further comprising:
receiving for each target flight path, a corresponding blackout area data having a list of the one or more blackout areas across the target flight path and the one or more intermediate nodes for each blackout area, wherein the blackout area data is to be provided to all UAM vehicles flying over the target flight path; and
receiving a signal coverage map based on a signal coverage data for the target flight path, wherein the signal coverage map indicates one or more areas where signal strength of communication signals received by the UAM vehicles from the ground station is above the predetermined signal strength threshold, and wherein the signal coverage data is to be provided to all UAM vehicles flying over the target flight path.
